(19) United States
(12) Patent Application Publication
(10) Pub. No.: US 2006/0051023 A1
(43) Pub. Date: Mar. 9, 2006

(54) Integrated optics sampling device and method for making same

(75) Inventor: Christophe Martinez, Grenoble (FR)

Correspondence Address: PILLSBURY WINTHROP SHAW PITTMAN, LLP, P.O. BOX 10500, MCLEAN, VA, 22102, US

(73) Assignee: Teem Photonics, Meylan (FR)

(21) Appl. No.: 10/538,063

(22) PCT Filed: Dec. 15, 2003
(86) PCT No.: PCT/FR03/50174

§ 371 Date: Jun. 9, 2005

(30) Foreign Application Priority Data
Dec. 16, 2002 (FR) 02 15918

(51) Int. Cl. G02B 6/34

(52) U.S. Cl. 385/37

(57) ABSTRACT

The invention relates to a sampling device comprising in a substrate (15), a wave guide core (17) capable of transporting a light wave E and an optical cladding (19), at least one portion of the cladding surrounding at least one portion of the core in a zone called the zone of interaction (I), the said zone comprising among others a grating (21) capable of coupling in the cladding, part of the light wave, the coupled part being called the coupled wave C, the refractive index of the cladding being different to the refractive index of the substrate and lower than the refractive index of the core at least in the part of the cladding next to the core in the zone of interaction. The cladding of the device is advantageously connected to a recovery and treatment element (33) for all or part of the coupled wave (C).

### TECHNICAL FIELD

This invention relates to an integrated optics sampling device as well as the fabrication method of this element.

The invention has applications in all fields requiring the sampling of a light wave for example to measure and/or check the characteristics of the wave. The invention is especially well suited to the field of optical amplifiers for sampling a light wave input and/or output of an optical amplifier or even in the field of spectral filters.

### STATE OF THE PRIOR ART

Currently, to sample a light wave, a coupler or a divider is generally used.

The coupler's parameters are set to sample from a light wave transported for a wave guide, whilst the divider's parameters are set to divide the initial light wave into determined parts.

FIG. 1 shows diagrammatically by means of a block diagram, a linear filter associated to a sampling device of the prior art for spectral checking of the filtering.

A source 2 is represented in this figure, emitting a light wave E of intensity I₀ in a thin spectral band assimilated to a single wave length. A sampling device 4 (a coupler for example) receives this signal of intensity I₀, sampled at I₁, with a sampling rate γ and transmits to the linear filter 8, a signal with an intensity I₀′. The output signal of the filter has an intensity I₂ such that the ratio between the signal I₂ issued from the filter and the sampled signal I₁ is expressed as follows:

$${I}_{2} / {I}_{1} = \frac{1 - γ}{γ} \times ( a \times d λ + {t}_{m} )$$

where dλ=λ−λₘ for a filter 8 of slope a around a central wave length λₘ and with a value tₘ at this wave length.

The signal I₂ measured at the filter output is therefore proportional to the emission wave length. If the latter changes, it is possible for example to correct this variation by servo controlling the spectral position of the source on the preceding measurement.

Even though this is satisfactory in certain respects, these devices comprise separate sampling and filtering elements which induces losses and makes the complete system more complex.

Furthermore, in the field of filters, an incident light wave is generally separated into two components of which one is transmitted and the other is not, at distinct spectral intervals, at the component output. However, for certain applications, it may also be useful to measure and/or check the part of the wave not transmitted.

In the field of optical fibres, to recover the part of the wave not transmitted, it is know to have a detection element, at the edge of the optical cladding. On this subject we can refer to the patent WO/0216979.

FIG. 2 shows diagrammatically an example of this type in the case of a an optical fibre filter formed for a long period grating.

FIG. 2 is a partial cross section of an optical fibre 1, comprising a core 3, an optical cladding 5 surrounding the core and a grating 7 made in a part of the core 3.

This cross section is in a plane which contains the direction z of propagation of the light wave in the core.

The grating 7 permits a zone of interaction to be created between the core and the cladding and to couple in the cladding, a part C (called the coupled wave) of an initial light wave E. The coupled wave C in the cladding is shown diagrammatically by arrows. At the output of the zone of interaction, the core thus transports the part S of the non coupled wave in the cladding.

After the zone of interaction, a detection element D such as a photo-detector, is positioned at the edge of the optical cladding.

In the optical fibres, the construction dependency between the core and the cladding means that the detection element can only be positioned at the edge of the cladding, if the propagation of the wave in the core is not to be disrupted. The axis of the detector is then perpendicular to the direction of propagation of the signal in the cladding. Consequently, only a part of the guided signal in the cladding is detected.

Furthermore, to improve the detection, it can be envisaged, as shown in FIG. 2, to create a cavity 6 in the fibre cladding to insert the detector. In spite of this layout, the detection element cannot detect the entire guided signal in the cladding, and furthermore the cavity that has to be machined in the cladding makes the component more fragile.

### DESCRIPTION OF THE INVENTION

The purpose of this invention is to propose an integrated optics sampling device which permits the problems of the prior art to be overcome.

In particular, the sampling device of the invention allows part of the light wave to be sampled for filtering, which avoids the problems related to couplers and dividers and permits, when using a cladding that is independent of a guide core, to recover the complete signal sampled at the output of the device.

More precisely, the sampling device of the invention comprises in a substrate, a wave guide core capable of transporting a light wave and an optical cladding, with at least one portion of the cladding surrounding at least one portion of the core in a zone called the zone of interaction, the said zone comprising along others a grating capable of coupling part of the light wave in the cladding, the coupled part of the wave being called the coupled wave, where the refractive index of the cladding is different from the refractive index of the substrate and lower than the refractive index of the core, at least in the part of the cladding next to the core in the zone of interaction.

By surrounding, it is meant that the fundamental profile mode of the guide core has a maximum amount that is included in the index profile of the cladding. In this way, the profile of the fundamental mode of the core may be totally or partially included in the index profile of the cladding, which results at structural level in a core that may be located anywhere at all in the cladding including at its edge, in which case the core may be partially outside of the cladding.

The cladding of the sampling device of the invention is generally associated to at least one recovery and treatment element so as to recover and treat all or part of the coupled wave. This element will be called the first recovery and treatment element.

Thus first recovery and treatment element associated to the device of the invention permits the recovery and then treatment of all or part of the coupled wave, which is the complementary part of the non coupled wave, with respect to the initial wave. Knowledge of the initial wave and the coupled wave permit the non-coupled wave to be characterised if necessary, which in general is the useful part of the light wave.

Of course, this sampling device may be associated to a second recovery and treatment element in order to recover and treat directly all or part of the non coupled wave of the core,

According to the invention, the core of the guide has a refractive index n_{c} and the optical cladding has a refractive index n_{g} such that n_{c}>n_{g}. Furthermore, a grating is created in the zone of interaction to couple at least one guided mode in the core, to one or more cladding modes. The cladding modes spread in the same direction as the core modes.

The coupling between the different modes takes place for a spectral band of central wave length λⱼ. By spectral band it is meant a band with a set of wavelengths with a central wave length and a determined band width, a light wave can comprise one or more spectral bands.

In the specific case of long period gratings, the coupling for an elementary grating between the different modes takes place for determined wave lengths λⱼ given for the following known relationship:
λⱼ=Λ×(n₀−nⱼ) (1)

where:

n₀ is the effective index of a guided mode in the core,

nⱼ is the effective index of the cladding mode number j,

λⱼ is the resonance wave length for the coupling in mode j,

Λ is the period of the grating.

Generally speaking, the coupling results in an energy transfer between the guided mode(s) in the core and the cladding mode(s) for the wave lengths λⱼ. The energy coupled in the cladding modes then spreads in the cladding (the cladding may be assimilated to a large specific guide) and the non coupled energy continues to spread in the core and has a power spectrum with energy losses for the wave lengths λⱼ on spectral bands called filtering bands.

When there is only a small difference between the effective indices n₀ and nⱼ (a few 10⁻² to a few 10⁻³) and the range of wave lengths concerned for the optical guiding is around 1.5 μm, the relationship (1) shows us that the grating periods are around a few dozen μm to a few thousands of μm.

The zone of interaction thus permits to filter spectrally part of the initial wave. The filtered part which is called the coupled or sampled part of the initial wave is then transported for the cladding whilst the non-filtered part which is to say the non-filtered part remains in the guide core.

The creation of the integrated optics sampling device permits the formation in the substrate of the wave guide core independently of the cladding and vice versa.

By independence of the core and the cladding, it is meant that they can exist in a substrate independently from one another. In other words, the core can exist without the cladding and the cladding can exist without the core, contrary to the fibres.

The independence of the core and the cladding thus makes possible more possibilities than with optical fibres. Thus, outside of the zone of interaction, the cladding may no longer surround the core, which makes it possible to have two distinct optical channels respectively formed for the core and the cladding. Thus the cladding only influences the propagation of a light wave in the associated guide core in the part which surrounds the core and the cladding can guide or transport light waves independently of the core.

The spatial separation of the core and the cladding permits the coupled signal to be recovered directly or not without any risk of interference with the non coupled signal transported in the core.

The first recovery and treatment element may thus be optically more easily to one end of the cladding without causing impedance for the core in order to recover all or part of the coupled wave in the cladding depending on the applications targeted.

According to a first embodiment, the first recovery and treatment element comprises an optical element which may advantageously be a measuring element, positioned directly at one end of the cladding to measure the filtered wave.

According to a second embodiment, the first recovery and treatment element comprises a second zone of interaction and an optical element which may for example be a measuring element; the second zone of interaction is formed in the substrate, for a second guide core situated in a portion of the cladding and for a grating capable of coupling, in the second core, the coupled wave which spreads in the cladding, the said core being optically connected outside of this second zone of interaction to the optical element.

The cladding does not necessarily have a uniform structure. In particular, the section of the cladding in the first zone of interaction may be larger than that of the second zone of interaction. Consequently, the section of the cladding between these two zones of interaction can be variable. Furthermore, the first and the second cores may be decentred with respect to one another in the cladding.

The characteristics of the second zone of interaction are however most often the same as those of the first zone of interaction as its function is to re-couple the coupled wave in the cladding, in the second core.

Regardless of the first or the second embodiments, it is possible to place at one end of the guide core the second recovery and treatment element, in order to recover and treat all or part of the non-coupled wave in the cladding. In this embodiment, the sampling device is thus associated to two recovery and treatment elements which can permit a double detection to be made: detection on the coupled signal in the cladding and detection on the non-coupled signal.

Advantageously, the first and/or second recovery and treatment element comprise(s) at least one optical element which is for example a measuring element such as a photo-detector or a group of photo detectors, capable of characterising at least spectrally the wave measured, or a suitable optical element for the application in question; this optical element may possibly be associated to a formatting element such as a lens, a lens fibre. The formatting element permits to target the wave to be measured on the photo-detector.

According to a third embodiment, in which the core and the cladding are not separate after the zone of interaction, the first and the second recovery and treatment elements form a single recovery and treatment element which comprises a matrix of optical elements such as photo-detectors with possibly an optical adaptation, with part of the matrix permitting the coupled wave to be recovered and possibly measured the other part of the matrix permitting the wave non coupled to be recovered and possibly measured.

In fact, thanks to the independence of the core and cladding, the size of the cladding can be adapted to a given matrix of detectors; this is not possible with the optical fibres which in particular have the disadvantage of a circular cladding which is consequently poorly adapted to the form of the matrix in lines and columns.

The characteristics of the one or more zones of interaction are determined following the one or more spectral bands of the wave that are to be sampled for coupling.

The efficiency of the coupling between the modes depends on the length of the grating and the coupling coefficient K_{0J} between the 0 and j modes. This coefficient is provided for the spatial recovery integral of the 0 and j modes, weighted for the index profile induced for the grating. We therefore have a relationship of the type:
K_{0J}∝∫∫ξ₀·ξ_{J}*·ΔΔns (2)

where:

ξ₀ and ξⱼ the transversal profiles of the 0 et j modes, and ξⱼ* the conjugate complex of ξⱼ,

Δn the amplitude of the effective index modulation induced for the grating in a plane perpendicular to the direction of propagation of the wave,

ds is an integration element in a plane perpendicular to the axis of propagation of the wave

The modification of K₀ⱼ is obtained by varying the profile of the modes and/or t induced he index profile of the grating, in other words by varying the opto-geometrical characteristics of the cladding and/or of the core (dimensions, index level, etc.) and/or the characteristics of the grating (Δn, position of the grating with respect to the core and the cladding, etc.).

In general, to modify the characteristics of the zones of interaction, the following parameters may be varied:

the length L of the grating,

its period Λ,

Δn the amplitude of the effective index modulation induced for the grating,

n_{co} the index of the core,

θ the phase of the grating.

According to the invention, the cladding is created artificially in the substrate, at least in the one or more zones of interaction and independently of the core and the substrate.

Generally speaking, we will call artificial cladding this type of cladding and artificial cladding grating, a zone of interaction.

The substrate can of course be created for a single material or for the superposition of several layers of material. In this case, the refractive index of the cladding is different to the refractive index of the substrate, at least in the layers next to the cladding.

Advantageously, each cladding has a refractive index higher than that of the substrate.

According to the invention, the integrated optics guide may be a planarian guide, when the light is confined in a plane containing the direction of propagation of the light or a micro guide, when the light is confined in two directions that are transversal to the direction of propagation of the light.

Furthermore, the grating of a zone of interaction is formed in the core of the guide and/or in the cladding and/or in the substrate. A grating may comprise a succession of elementary gratings. It may be periodic or pseudo-periodic.

Thus, for example for a cladding, the bigger its dimensions and index level, then the higher the number of cladding modes allowed to spread and the more spectral filtering bands will be possible. This can be an advantage if looking for multiple filtering or to have more choice in the selection of a filtering mode.

If the aim is to limit the number of cladding modes that can be coupled, it is on the contrary better to reduce the opto-geometrical dimensions of the cladding.

As concerns the core, its dimensions and index level determine the characteristics of the mode that spreads there. Furthermore, the higher the differences of index between the core, the cladding and the substrate, the more chance there is potentially of having couplings for low grating periods as shown by the equation (1) (at a wave length of given resonance, the period is inversely related to the difference of index between the guided mode of the core and the cladding mode).

By modifying the position of the core, the grating and the cladding, different couplings may be generated. In fact, we can see clearly from the equation (2) that the coupling force depends on the relative position in the transversal plane to the axis of propagation of the profiles of the cladding mode, of the guided mode in the core and of the grating.

The sampling device of the invention may be used with many optical components. It is particularly useful in the case of filtering components such as linear filters or gain flatteners used for example with optical amplifiers.

In this case and according to one particularly advantageous embodiment, the zone of interaction of the sampling device is created so that It both filters and samples. The parameters of the zone of interaction are therefore adapted to the desired filtering function, which may or may not be of the evolved type, the grating of the zone of interaction comprises at least two elementary gratings.

Thus, the parameters for each elementary zone of interaction associated to an elementary grating may be at least selected from the following:

the length L of the grating or elementary gratings,

the period Λ of the grating or elementary gratings,

the profile of the grating or elementary gratings,

the position of the grating or elementary gratings in the corresponding zone of interaction,

Δn the amplitude of the effective index modulation induced for the grating or the elementary gratings,

θ the phase of the grating or elementary gratings,

the dimensions of the cladding which may be variable,

the dimensions of the core which may also be variable,

the value of the refractive index of the cladding which may also be variable,

n_{co} the value of the index of the core in the substrate,

the position or the positions of the core in the cladding.

According to one preferred embodiment, the cladding and/or the core of the guide and/or the grating may be created for all types of technique permitting the refractive index of the substrate to be modified. We can mention in particular the ion exchange techniques, the ionic implantation and/or radiation for example for laser exposure or laser photo inscription or even the depositing of layers.

The ion exchange technology in glass is of particular interest but other substrates than glass may of course be used, such as for example the crystalline substrates of the KTP or LiNbO₃ types, or even LiTaO₃.

More generally, the gratings may be created for all techniques permitting the effective index of the substrate to be changed. To the techniques we have already mentioned, we can therefore add in particular the grating creation techniques for etching the substrate. This etching can be carried out above the cladding or in the portion of cladding of the zones of interaction and/or possibly in the core portion of the zones of interaction .

The pattern of the grating may be obtained either for laser sweeping if radiation is used, or for a mask. The latter may be the mask which permits the core and/or the cladding or a specific mask to be obtained to create the grating.

The invention also relates to a fabrication method of a sampling device as previously defined, the cladding, the guide core and the grating being respectively created to modify the refractive index of the substrate so that at least in the part of the cladding next to the core and at least in each zone of interaction, the refractive index of the cladding is different from the refractive index of the substrate and lower than the refractive index of the core.

According to a preferred embodiment, the method of the invention comprises the following steps:

a) introduction of a first ionic species in the substrate so as to permit the optical cladding to be obtained after step c),

b) introduction of a second ionic species in the substrate so as to permit the guide core to be obtained after step c),

c) burying of the ions introduced in steps a) and b) so as to obtain the cladding and core of the guide,

d) creation of the grating.

The order of the steps may of course be inverted.

The introduction of the first and/or second ionic species is advantageously made for an ionic exchange, or for ionic implantation.

The first and second ionic species may be the same or different.

The introduction of the first ionic species and/or the second ionic species may be made with the application of an electrical field.

In the case of an ionic exchange, the substrate must contain ionic species capable of being exchanged.

According to one preferred embodiment, the substrate is made of glass and contains Na+⁺ ions introduced beforehand, and the first and second ionic species are Ag⁺ and/or K⁺ ions.

According to a first embodiment, the step a) comprises the creation of a first mask comprising a pattern capable of obtaining the cladding, the first ionic species being introduced through this first mask and step b) comprises the elimination of the first mask and the creation of a second mask comprising a pattern capable of obtaining the core, the second ionic species being introduced through this second mask.

According to a second embodiment, the step a) comprises the creation of a mask comprising a pattern capable of obtaining the cladding and the core, the first and the second ionic species of steps a) and b) being introduced through this mask. This embodiment is in general limited to the case of the core and the cladding not being separated in the substrate.

The masks used in the invention are for example made of aluminium, chrome, alumina or dielectric material.

According to a first embodiment of the step c), the first ionic species is buried at least partially before step b) and the second ionic species is buried at least partially after step b).

According to a second embodiment of the step c), the first ionic species and the second ionic species are buried simultaneously after step b).

According to a third embodiment of the step c), the burying comprises a deposit of at least one layer of refractive index material advantageously lower than that of the cladding, on the surface of the substrate.

This mode may of course be combined with the two previous modes.

Advantageously, at least a part of the burying is carried out with the application of an electrical field.

Generally before the burying under a field and/or the depositing of a layer, the process of the invention may comprise among others burying for re-diffusion in an ionic bath.

This re-diffusion step may be carried out partially before step b) to re-diffuse the ions of the first ionic species and partially after step b) to re-diffuse the ions of the first and second ionic species. This re-diffusion step may also be carried out completely after step b) to re-diffuse the ions of the first and second ionic species.

By way of example this re-diffusion is obtained by plunging the substrate in a bath containing the same ionic species as that formerly contained in the substrate.

Step d) of the creation of the grating may be carried out independently of steps a) and b) or be carried out simultaneously during step a) and/or step b) by using the same masks for example.

Other characteristics and advantages of the invention will become clearer in the following description, in reference to the figures of the appended drawings. This description is given purely by way of illustration, and is non-restrictive.

### BRIEF DESCRIPTION OF THE FIGURES

FIG. 1, already described, diagrammatically shows a block diagram of a filtering device with a sampling device of the prior art,

FIG. 2, already described, diagrammatically shows a cross section of an optical fibre with a known sampling element,

FIG. 3 diagrammatically shows a cross section of a first embodiment of a sampling device of the invention,

FIG. 4 diagrammatically shows a cross section of a second embodiment d′un sampling device of the invention,

FIG. 5 diagrammatically shows a section of a variant of the embodiment of FIG. 3,

FIG. 6 diagrammatically shows a section of a variant of the embodiment of FIG. 4 in which the cladding has a variation of section,

FIGS. 7a and 7b diagrammatically show a cross section of a third embodiment of a sampling device of the invention,

FIG. 8 diagrammatically shows a cross section of an example of an application of a sampling device of the invention with an amplification device,

FIG. 9 diagrammatically shows a section of another application example of a sampling device of the invention with a filtering device,

FIGS. 10a to 10d diagrammatically show a cross section of an example of the creation process of a sampling element of the invention,

FIGS. 11a to 11d diagrammatically show variants of the creation of the mask pattern permitting a grating to be made, and

FIG. 12 shows in cross section a variant of the embodiment of the device of the invention, with a grating in the cladding.

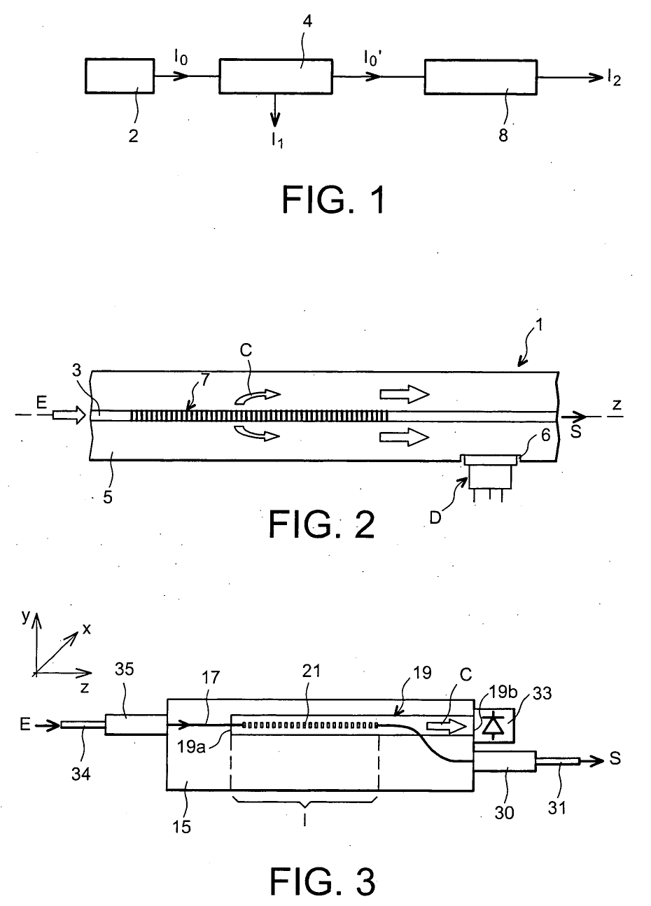

### DETAILED DESCRIPTION OF EMBODIMENTS OF THE INVENTION

To simplify the description, by way of example, we will consider that the zone of interaction only comprises an elementary grating included in the guide core of the device.

FIG. 3 diagrammatically shows in cross section a first example of a sampling device of the invention made in integrated optics.

This cross section is in a plane parallel to the surface of the substrate containing the direction z of propagation of the light wave.

This sampling device comprises in a substrate 15, a wave guide core 17, a cladding 19 and a grating 21 created by way of example in part of the core. The zone of interaction I corresponds to a zone of the substrate in which the core, the cladding and the grating are present.

As we have already seen, the independence of the core and the cladding permits more flexibility and in particular to dissociate the core and the cladding. Thus, outside of the zone of interaction, the cladding can no longer surround the core. The cladding only influences the propagation of a light wave in the associated guide core in the part surrounding the core and the cladding can guide or transport light waves independently of the core. In this way, the wave transported for the cladding may be recovered more easily at one end of the cladding without being hampered by the core

In this figure, the recovery and treatment element 33 can thus be optically connected more easily to one end of the cladding without being hampered by the core and recover all or part of the coupled wave in the cladding depending on the applications in question.

In the embodiment of FIG. 3, the cladding 19 surrounds the core 17 solely in the zone of interaction I comprising the grating 21. In other words the core 17 carrying an input light wave E, penetrates the cladding by one of its ends with the reference 19a and leaves it after the zone of interaction I by carrying a wave S corresponding to the part of the wave E that has not been coupled to the cladding in the zone of interaction. The coupled part of the wave has the reference C. The core may be connected upstream and/or downstream of the zone of interaction to optical elements (not shown) which may or may not be integrated in the substrate 15.

In this example, the input of the core 17 is optically coupled to an optical fibre 34 and at its output to an optical fibre 31 by means of to des ferulae respectively with the references 35 and 30.

To make a double detection from the sampling device of this figure, then the fibre 31 simply has to be connected to a second recovery and treatment element (not shown). Thus, the coupled wave C in the cladding is measured at the output of the cladding for the element 33 and the complementary output wave S is measured at the output of the core 17 for the second recovery and treatment element.

In this embodiment, the recovery and treatment element 33 comprises an optical element which is advantageously a measuring element such as a photo detector possibly associated to adaptive optics; this element 33 is positioned directly at the end 19b of the cladding. If the input of the measuring element is adapted to the end 19b of the cladding or vice versa, then all the coupled wave C in the cladding may be recovered for the measuring element.

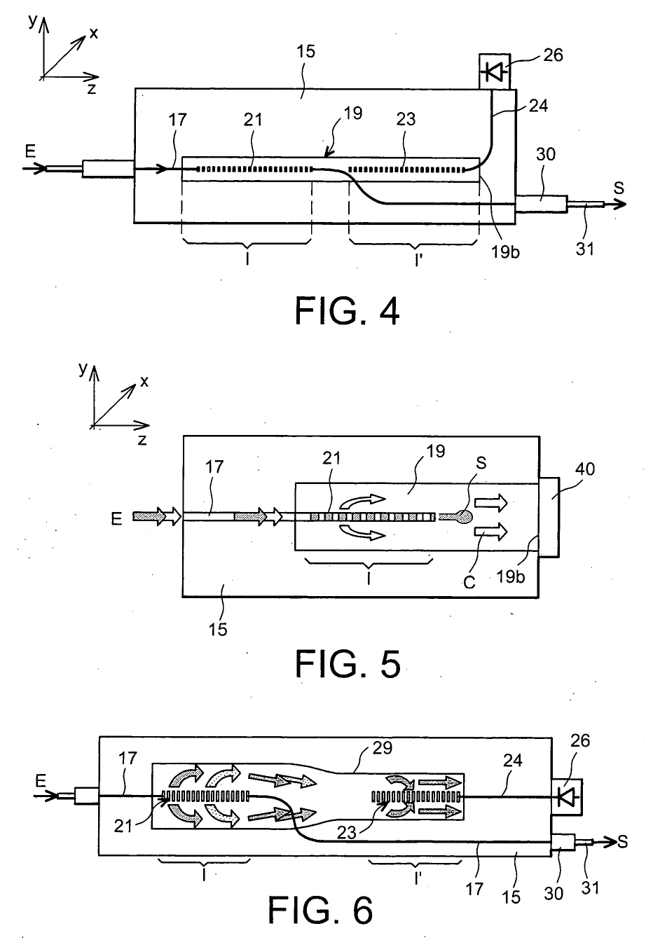

FIG. 4 diagrammatically shows in cross section a second example of sampling device of the invention created in integrated optics.

This cross section is also in a plane parallel to the surface of the substrate and containing the direction z of propagation of the light wave.

This figure can be distinguished from FIG. 3 by the recovery and treatment element which comprises a second zone of interaction I′ capable of coupling the wave C spreading through the cladding 19, in a second core 24 and an optical element 26.

More precisely, the zone I′ is formed in the substrate 15 for a second guide core 24 situated in a portion of the cladding 19 and for a grating 23 capable of coupling in the second core all or part of the wave C spreading through the cladding. In this example, this is the core 24 which leaves the cladding by the end 19b, which is connected to the optical element 26.

The characteristics of the second zone of interaction are most often the same as those of the zone of interaction I as its function is to couple the wave C in the second core.

This embodiment is a little more complex than the previous one but has the advantage of making possible the recovery of the coupled wave on a normal sized guide. The core 24 can then be connected either directly or via an optical fibre to the optical element 26.

This type of component can also be used as a multiplexer/demultiplexer in which case the core 24 is connected to an optical element depending on the application in question.

As in FIG. 3, the non coupled wave transported for the core at the output of zone I can be recovered and treated.

FIG. 5 diagrammatically shows a cross section in a plane parallel to the surface of the substrate and containing the direction z of propagation of the light wave, a variant of FIG. 3. In this example, only the wave C is recovered.

This cross section is distinguished from that of FIG. 3, in that the core 17 does not leave the zone of interaction I. The non coupled wave S in the cladding is dispersed inside it without being recovered, whilst the wave C is coupled and guided in the cladding is recovered for the recovery and treatment element 40 connected to the end 19b of the cladding.

The optical element 33 (of FIG. 3), 26 (of FIG. 4) or 40 (of FIG. 5) is advantageously a photo detector or a group of photo detectors, capable of characterising at least spectrally the measured wave possibly associated to a formatting element such as a lens, a lens fibre to target the wave to be measured on the photo detector.

The characteristics of the zone(s) of interaction are determined depending on the one or more spectral bands of the initial wave E that are to be filtered.

FIG. 6 diagrammatically shows in cross section in a plane parallel to the surface of the substrate and containing the direction z of propagation of the light wave, a variant of FIG. 4. This figure is distinguished from the FIG. 4 by the cladding 29 which creates the two zones of interaction I and I′, the other elements are the same as those of FIG. 4 and have the same references.

The cladding 29 has a variation of section between the two zones of interaction I and I′ in order to modify the distribution of the guided modes in the cladding. Thus, each of these zones of interaction I and I′ is characterised for a spectral transfer function respectively T1 and T2 defined for the grating selected 21, 23, the size of the core 17, 24 and the size of the cladding. In the case of this example, the two cores 17 and 24 have the same size. The change in the size of the cladding then permits not only the position of the filtering bands to be changed absolutely (with respect to a fixed reference) but also relatively (of the maximums between the transfer functions).

Thus, if the pitch of the two gratings 21, 23 is adjusted so that the maximums are at the same spectral position for the two gratings, then at the central wave length corresponding to this maximum, the first grating 21 will couple the fundamental mode of the core 21 to a cladding mode; this mode will then be guided in the cladding 19 up to the other grating 23. The inverse coupling will then take place and the signal filtered for the grating 21 will be situated in the core 24. For the other coupled spectral bands, the cladding 19 will also guide the coupled modes to the second grating 23 but the change of size of cladding means that the core 24 can no longer be coupled with the second grating. At the core output 24, only one of the coupled modes in the cladding can be recovered.

To modify the distribution of the guided modes in the cladding, it is also possible to decentre the core 17 with respect to the other core 24. Such a decentration permits, as previously seen, to add a filtering element between the two zones of interaction placed in series for a common cladding.

It is of course possible to combine the decentration of the two cores and the variation of the cladding section.

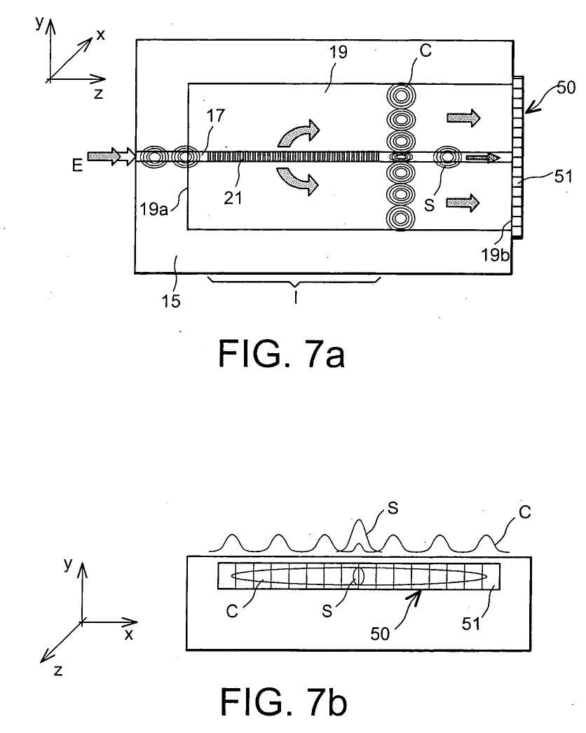

FIGS. 7a and 7b show diagrammatically the device of the invention respectively in a cross section in a plane (xz) parallel to the surface of the substrate and containing the direction z of propagation of the light wave (FIG. 7a) and in a plane (yx) perpendicular to the surface of the substrate and perpendicular to the direction z of propagation of the light wave (FIG. 7b).

These figures offer another solution for performing double detection. FIG. 7a is shows in the substrate 15 a zone of interaction I formed for the cladding 19, the guide core 17 and the grating 21. In this example, the core penetrates the cladding by the end 19a and transverses it to its output end 19b without being separated from the cladding.

A recovery and treatment element 50 is then connected conjointly to the output ends of the core and the cladding. This element is for example a CCD matrix type detection unit (which is to say a matrix detector unit) possibly associated to adaptation optics. In FIGS. 7a and 7b, the element 50 is a strip of detectors 51.

FIG. 7b is a cross section in the plane of these detectors.

Thus, as previously seen part of the input light wave E is coupled (wave C) in the zone of interaction I whilst the non coupled part (wave S) continues to be transported by the core 17. The concentric circles respectively with the references C and S diagrammatically show these waves.

The wave S is recovered for one or more detectors located in the centre of the matrix whilst the wave C is recovered for the other detectors.

In fact, if the section of the cladding is large enough, the cladding mode(s) have their energies mainly distributed outside of the central zone. The distribution of the energies of the waves C and S is shown diagrammatically by way of example above the strip of detectors FIG. 7b. Consequently, the central detection elements provide the measurement of the signal S and the other elements of the matrix provide the measurement of the complementary signal C.

The independence of the core and the cladding furthermore permit the size of the cladding to be adapted to a given matrix of detectors. Even though the cladding of an optical fibre is circular and poorly adapted to the line form of the detectors.

The sampling device of the invention may be used with many optical components. It is particularly useful with filtering components such as linear filters or gain flatteners used for example with optical amplifiers to permit the amplifier to be controlled.

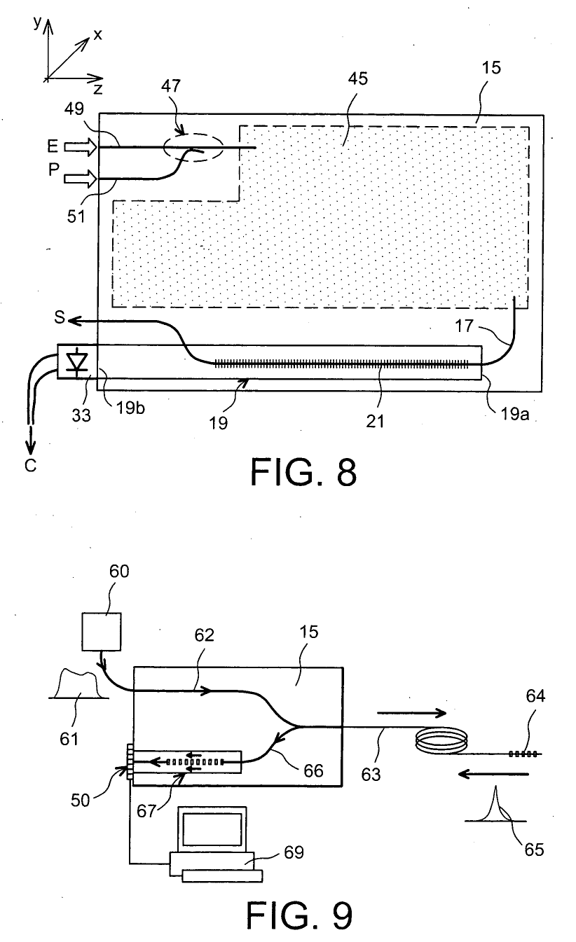

FIG. 8 shows precisely by way of example the use of a sampling device of the invention with an optical amplifier.

This figure is in a plane yz containing the sampling device of the invention which in this example is of the same type as that of FIG. 3. The optical amplifier associated to this sampling device is integrated in the same substrate 15 as the latter. It comprises an amplification element shown schematically by a shaded zone 45 which may be a spiral guide core whose input is connected to a coupler 47 and whose output is connected to the core 17 of the sampling device.

The coupler 47 comprises a first input connected to a guide core 49 from which the light wave E is introduced to be amplified and a second input connected to a guide core 51 from which a pump wave P capable of pumping the active zone 45 is introduced. The coupler 47 permits the amplifying element which is connected to the coupler output to be supplied with the waves to be amplified and pump. At the amplifier output, the core 17 thus transports the amplified wave E.

In general, due to the non homogeneity of the gain of the active 45 on the amplification spectral band, the amplified wave undergoes deformation. A gain flattener filter is therefore advantageously connected to the amplifying element 45 output. Thus filter is, in the invention, created for one or more artificial cladding gratings to coupler in a cladding 19 the amplification excess of the wave E. The sampling device is then used as a filter as it permits the wave non transmitted for the core 17 to be recovered at the output of the cladding 19. A recovery and treatment element of the wave C is therefore optically connected to the end 19b of the cladding whilst the output wave S is available at the output of the core 17.

As the non transmitted light energy C of the wave is proportional to the energy S transmitted, by the core 17, the measurement of the energy guided in the cladding mode(s) permits the output power level of the amplifier to be controlled.

This control is especially important when a constant level of amplification must be ensured in time.

The use of the non transmitted signal by the core 17 and consequently lost, to control the output power level of the amplifier has the double advantage of not requiring any additional coupler type components to carry out the sampling and not introducing any output losses. In FIG. 8, the sampling device and the amplifying element are made in the same substrate, but of course these two elements may be made in two substrates that are different or the same, the amplifying element can be an amplifying fibre connected to the sampling device made in a substrate.

FIG. 9 shows diagrammatically in a cross section, another application of the sampling device pour the spectral control of a linear filter.

In this figure, a source 60 with a wide spectrum 61 (shown close to the source) is optically connected to a guide core 62 made in a substrate 15. The core 62 guides the signal from the source to an optical fibre 63 comprising a Bragg grating 64. The latter reflects a fine spectral band 65 (shown close to the grating 64) in the fibre 63. The spectral band signal 65 then returns into the substrate 15 by a guide core 66 made in the said substrate. The core 66 transports this signal to a sampling device 67 of the invention.

In this example, the device 67 is of the same type as that shown in FIGS. 7a and 7b. The strip of photo detectors 50, for example a CCD strip, is connected to the ends of the cladding and the core of the sampling device and measures the filtered signals I₁ and non filtered signals I₂ of the zone of interaction. A central analysis unit 69 is for example connected to the strip 50 to treat the signals measured.

When the Bragg grating is subjected to parameter variations (temperature, constraints, etc.) the reflected wave length varies. The signal measured at the output of the sampling device of the invention thus permits the value of this variation to be determined.

The sampling device of the invention permits functions that are more or less evolved to be created by modifying the various elements of the artificial cladding grating. The latter permits a linear signal to be transmitted depending on the wave length at a given range. Thus, if λₘ is the central wave length of the filter, the transmission is given for a relationship of the following type close to this wave length:
T(λ)=a×(λ−λₘ)+tₘ (3)

If we measure simultaneously the signal transmitted I₂ and its complementary signal I₁ in decibels (for example a CCD strip) and that the two are separated, we obtain:
I₂^{dB}−I₁^{dB}=10log(1−tₘ−a×dλ−10log(tₘ+a×dλ) (4)

Thus, contrary to the prior art, the double detection is carried out in the same device, which permits the measurement to be made insensitive to intermediate losses and insensitive to fluctuations of intensity of the measurement.

Furthermore, the use of an artificial cladding grating of the invention has the double advantage of both performing the filtering function as well as that of sampling, which is a gain in cost and space.

To resolve any possible problems of non linearity of the measurement depending on the spectral offset, the spectrum of the component may be adapted. Thus, if desired:
I₂/I₁=α×dλ+βₘ (5)

The response of the sampling device simply needs to be adjusted of so as to have a defined transmission on the useful spectral band from the equation:

$$T ( λ ) = \frac{1}{1 + α \times ( λ - {λ}_{m} ) + {β}_{m}} \qquad ( 6 )$$

This system may be applied in particular to the frequency control of a fine source or the offset measurement of Bragg grating sensors.

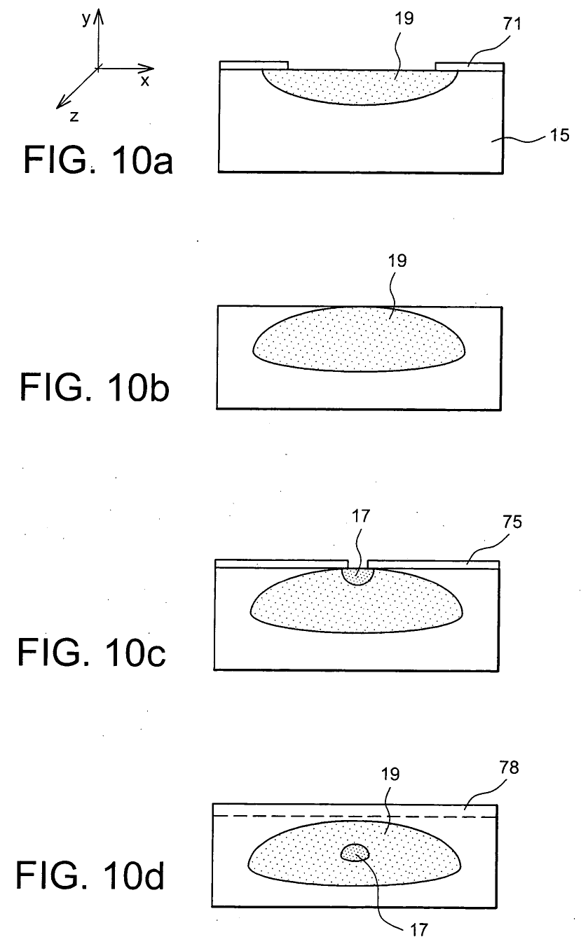

Hereunder is described in conjunction with the FIGS. 10a to 10d an embodiment, using the ion exchange technology, of a zone of interaction I used in a sampling device of the invention.

These figures are cross sections of the zone I in a plane xy.

Thus, FIG. 10a shows the substrate 15 containing beforehand B ions. A first mask 71 is created for example by photolithography one of the faces of the substrate; this mask comprises an opening determined according to the dimensions (width, length) of the cladding 19 that are to be obtained.

A first ionic exchange is then carried out between the A ions and B ions contained in the substrate, in a zone of the substrate situated close to the opening of the mask 71. This exchange is obtained for example by soaking the substrate equipped with the mask in a bath containing A ions and by possibly applying an electrical field between the face of the substrate on which the mask is positioned and the opposite face. The zone of the substrate in which this ionic exchange has been made forms the cladding 19.

To bury this cladding, a step of re-diffusing the A ions is carried out with or without the help of an electrical field applied as previously described. FIG. 10b shows the cladding after a step where it is partially buried. The mask 71 is generally removed prior to this step.

The creation of the cladding of the invention is therefore similar to the creation of a guide core but with different dimensions.

The following step represented in FIG. 10c consists of forming a new mask 75 on the substrate for example by photolithography possibly after cleaning the face of the substrate on which it is made. This mask comprises patterns capable of permitting a guide core 17 to be made and in particular when the core comprises a grating, the mask patterns 75 may be adapted to the grating patterns to be formed.

A second ionic exchange is then carried out between the B ions of the substrate and the C ions which may or may not be the same as the A ions. This ionic exchange may be carried out as previously described by soaking the substrate in a bath containing C ions and by possibly applying an electrical field.

Finally, FIG. 10d shows the component obtained after burying of the core 17, obtained by re-diffusion of the C ions and final burying of the cladding, with or without the use of an electrical field. The mask 75 is generally removed prior to this burying step.

The conditions of the first and second ionic exchanges are defined so as to obtain the desired differences in the refractive indices between the substrate, the cladding and the core. The adjustment parameters of these differences are in particular the exchange time, the temperature of the bath, the concentration in ions of the bath and the presence or absence of an electrical field.

In one example of an embodiment, the substrate 15 is made of glass containing Na⁺ ions, the mask 71 is made of aluminium and if the cladding is uniform it has an opening of around 30 μm in width (the length of the opening depends on the desired length of cladding for the application in question).

The first ionic exchange is performed with a bath comprising Ag⁺ ions at a concentration of approximately 20%, at a temperature of around 330° C. and during an exchange time of around 5 minutes. Re-diffusion of the ions first takes place in open air at a temperature of around 330° C. for 30 s, then the cladding is partially buried in the glass. This burying is carried out for a re-diffusion in a sodium bath at a temperature of around 260° C. for 3 minutes.

The mask 75 is also made of aluminium and has an opening pattern of around 3 μm in width (the length of the pattern depends on the desired core length for the application in question).

The second ionic exchange is performed with a bath also comprising Ag⁺ ions at a concentration of around 20%, at a temperature of around 330° C. and for an exchange time of around 5 minutes, with a re-diffusion of the ions first taking place in open air at a temperature of around 330° C. and for 30 s. Then the core thus formed in the glass is partially buried by re-diffusion in a sodium bath at a temperature of around 260° C for 3 minutes.

The cladding and the core are finally buried under an electrical field, with the two opposite faces of the substrate in contact with two baths (in this example of sodium) capable of allowing a difference in potential to be applied between these two baths.

Many variants of the previously described process may course be made.

As we have already seen, to bury the cladding and the core, a variant of the process consists of depositing on the substrate 15, a layer of material 78, shown in dotted lines in FIG. 10d. To make optical guiding possible, this material must advantageously have a refractive index lower than that of the cladding.

The fabrication of the component of the invention is not limited to the ion exchange technique. The component of the invention may of course be made by all techniques which permit the refractive index of the substrate to be modified.

Furthermore, as we have already seen, the period, the size, the position of the grating created, with respect to the core and the cladding, are parameters which can be adapted to suit the applications.

The pattern of the grating can be defined on the mask permitting the cladding to be created and/or on the mask permitting the core to be created or solely on the mask permitting both the cladding and the core to be created or even on a specific mask solely for the creation of the grating.

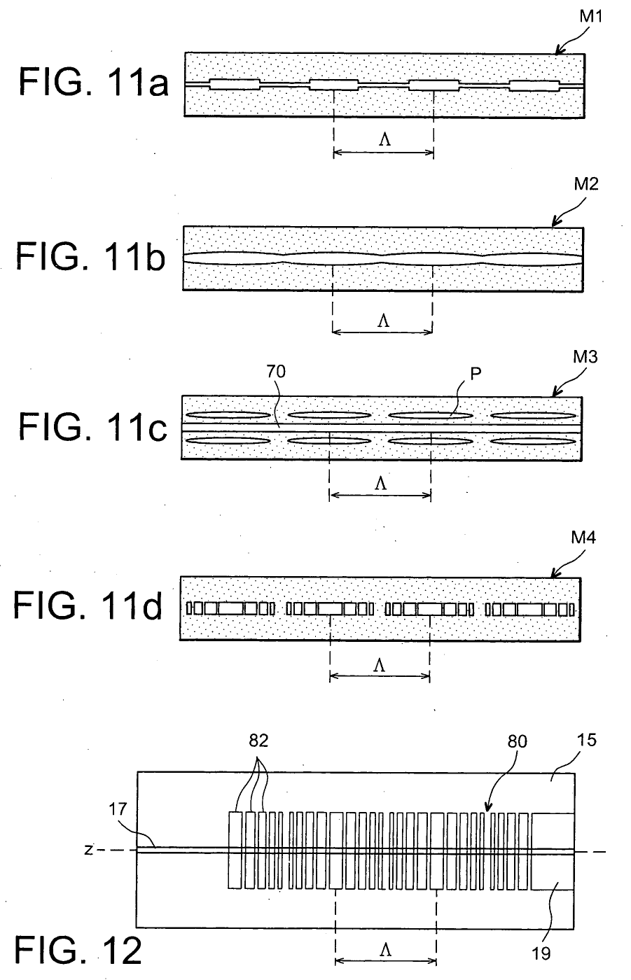

FIGS. 11a to 11d show examples of embodiments of masks M1, M2, M3, M4 permitting an elementary grating to be created. These figures are elevation views of masks and only show the part of the masks permitting the grating to be created. The white zones of the pattern of the masks are the openings of the masks.

These masks permit a periodic grating of period Λ to be obtained. The mask M4 permits a grating to be obtained for segmentation whilst the masks M1 and M2 permit a grating to be obtained for variation of the width of the patterns. Furthermore, the mask M3 permits a grating to be obtained for the introduction of a periodic disruption P in the substrate for example next to the core 70.

The previous figures show examples of gratings formed in the guide core.

FIG. 12 shows an embodiment of an elementary grating 80 created for segmentation in a zone of interaction, both in the core 17 and in the cladding 19.

Thus, in FIG. 12, the grating 80 is formed in the cladding 19 by alternation of period A of zones 82 of variable lengths considered in the direction z of propagation of a light wave. As the core is furthermore included in the cladding, at least in the zone of interaction, the grating is also included in the core, in other words the core also comprises refractive index zones that are different from that of the rest of the core.

The gratings may be formed by all of the traditional techniques permitting the effective index of the substrate to be modified locally in the core and/or in the cladding.

They can therefore be created during ionic exchanges permitting the core and/or the cladding to be created or during a specific ionic exchange. They can also be obtained by etching of the substrate on the zone of interaction or by radiation. In particular, the gratings may be obtained by exposure of the core and/or the cladding with a CO₂ type laser. By producing localised heating, the laser permits ions to be re-diffused locally and thus include the grating pattern.

By way of example, the substrate can be swept with a laser beam modulated for example by its amplitude so as to introduce modulation of the grating to the desired pitch.

The pattern of the grating depends on the applications targeted. In particular, the grating may have a variable period (chirped grating) or variable efficiency (apodised grating).

1. A sampling device comprising:
a substrate;
a wave guide core in the substrate, the wave guide core being configured to transport a light wave; and
an optical cladding in the substrate,
wherein at least a portion of the cladding surrounds at least a portion of the core in a zone of interaction, said zone comprising a grating configured to couple, in the cladding, a part of the light wave to form a coupled wave,
wherein a refractive index of the cladding is different from a refractive index of the substrate and the refractive index of the cladding is lower than a refractive index of the core at least in a part of the cladding adjacent to the core in the zone of interaction.

2. The sampling device of claim 1, further comprising a a first recovery and treatment element,
wherein the cladding is optically connected to the first recovery and treatment element and the first element is configured to recover and treat at least a portion of the coupled wave.

3. The sampling device of claim 1, further comprising a a second first recovery and treatment element,
wherein the core is optically connected to the second recovery and treatment element and the second element is configured to recover and treat at least a portion of a non coupled wave in the cladding.

4. The sampling device of claim 1, wherein the core and the cladding are spatially separated after the zone of interaction.

5. The sampling device of claim 1, wherein the cladding and the core are optically connected to a same recovery and treatment element comprising a set of optical elements.

6. The sampling device of claim 2, wherein the first recovery and treatment element, comprises an optical element positioned directly at an end of the cladding.

7. The sampling device of claim 2,
wherein the first recovery and treatment element comprises a second zone of interaction and an optical element,
wherein the second zone of interaction is formed in the substrate, by a second guide core located in a portion of the cladding and by a second grating configured to couple, in the second core, the coupled wave in the cladding,
wherein said second core is optically connected to the optical element outside of said second zone of interaction.

8. The sampling device of claim 7, wherein the first core and the second core are decentred with respect to each other in the cladding.

9. The sampling device of claim 3, wherein the second recovery and treatment element comprises an optical element connected to the core.

10. The sampling device of claim 5, wherein an optical element in the set of optical elements is a photo-detector or a group of photo detectors.

11. The sampling device of claim 1, wherein the grating of the zone of interaction is formed in the guide core, in the cladding, in the substrate, or in any combination thereof.

12. The sampling device of claim 1, wherein the sampling device is optically connected to an output of an optical amplification element.

13. The sampling device of claim 12, wherein the sampling device is configured to flatten a gain at the output of the amplification element.

14. The sampling device of claim 1, wherein the zone of interaction performs filtering and sampling.

15. A fabrication method of an integrated optics sampling device comprising a substrate; a wave guide core in the substrate, the wave guide core being configured to transport a light wave; and an optical cladding in the substrate, wherein at least a portion of the cladding surrounds at least a portion of the core in a zone of interaction comprising a grating, the method comprising:
creating the core and the cladding by modifying the refractive index of the substrate so that in at least a part of the cladding next to the core and in at least the zone of interaction, a refractive index of the cladding is different from a refractive index of the substrate and the refractive index of the cladding is lower than a refractive index of the core; and
creating the grating by modifying an effective index of the substrate.

16. The fabrication method according to claim 15, wherein modifying the refractive index of the substrate comprises irradiating the substrate, introducing ionic species into the substrate, or both.

17. The fabrication method of claim 16, comprising:
introducing a first ionic species in the substrate,
introducing a second ionic species in the substrate,
burying the first and/or second ionic species introduced so as to obtain the cladding and the guide core,
forming one or more gratings.

18. The fabrication method of claim 17, wherein introducing the first and/or second ionic species is carried out by an ionic exchange or by ionic implantation.

19. The fabrication method of claim 17, wherein the substrate comprises glass and contains Na+ ions, and the first and the second ionic species are Ag+ ions, K+ ions, or both.

20. The fabrication method of claim 17,
wherein introducing the first ionic species in the substrate comprises:
creating a first mask comprising a pattern configured to form the cladding, and
introducing the first ionic species through the first mask,
wherein introducing a second ionic species in the substrate comprises:
eliminating the first mask, and
creating a second mask comprising a pattern configured to form the core, and
introducing the second ionic species through the second mask.

21. The fabrication method of claim 15, wherein forming one or more gratings comprises introducing ionic species through a same mask used to form the core and/or the cladding or by a specific mask.

22. The fabrication method of claim 15, wherein forming one or more gratings comprises heating locally the substrate.

23. The fabrication method of claim 15, wherein forming one or more gratings comprises etching the substrate in the vicinity of the zone of interaction.

24. The fabrication method of claim 17, wherein burying the first ionic species is at least partially performed before introducing the second ionic species in the substrate and burying the first ionic species and the second ionic species is performed after introducing the second ionic species in the substrate.

25. The fabrication method of claim 17, wherein burying the first ionic species and the second ionic species is performed after introducing the second ionic species in the substrate.

26. The fabrication method of claim 17, wherein the burying comprises applying an electrical field.

27. The fabrication method of claim 17, wherein the burying comprises re-diffusing the ionic species in an ionic bath.

28. The fabrication method of claim 17, wherein the burying comprises depositing at least one layer on a surface of the substrate.

29. The fabrication method of claim 17, wherein introducing the first ionic species and/or the second ionic species comprises applying an electrical field.

30. The sampling device of claim 7, wherein the cladding comprises a variation of section along a length of the cladding from the first zone of interaction to the second zone of interaction.

31. The sampling device of claim 5, wherein the photo-detector is associated with a formatting element.
